(19) United States
(12) Patent Application Publication
(10) Pub. No.: US 2022/0015385 A1
(43) Pub. Date: Jan. 20, 2022

(54) HERBAL COMBINATION TO BE USED AS A COFFEE REPLACEMENT AND/OR AS A COFFEE FLAVOR ENHANCER AND METHODS OF MAKING SAME

(71) Applicants: Uma Swaminathan, East Brunswick, NJ (US); Kaushik Swaminathan, East Brunswick, NJ (US)

(72) Inventors: Uma Swaminathan, East Brunswick, NJ (US); Kaushik Swaminathan, East Brunswick, NJ (US)

(21) Appl. No.: 17/141,951

(22) Filed: Jan. 5, 2021

Related U.S. Application Data
(60) Provisional application No. 63/053,782, filed on Jul. 20, 2020.

(51) Int. Cl. A23F 5/44; A23L 27/10; A23F 5/46

(52) U.S. Cl. CPC A23F 5/44; A23F 5/465; A23L 27/10

(57) ABSTRACT

In some examples, a method of manufacturing a coffee flavoring or coffee substitute, include providing a predetermined amount of blackseeds, providing a predetermined amount of asafoetida, and roasting the predetermined amount of blackseeds and the predetermined amount of asafoetida.

### RELATED APPLICATIONS

The present disclosure claims priority to U.S. Provisional Ser. No. 63/053,782, filed Jul. 20, 2020, entitled “HERBAL COMBINATION TO BE USED AS A COFFEE REPLACEMENT OR AS A COFFEE FLAVOR ENHANCER,” the disclosure of which is hereby incorporated by reference in its entirety as if fully set forth herein.

### FIELD OF THE DISCLOSURE

The present disclosure generally relates to beverages. More particularly, the present disclosure relates to methods of composition for making coffee enhancers and coffee substitutes.

### BACKGROUND OF THE DISCLOSURE

In the field of coffee beverages, there have been various attempts at adjusting the flavor and/or aroma of beverages to duplicate the flavor of coffee in accordance with consumer tastes. However, none of these beverages has reached a satisfactory level in flavor or taste. Additionally, many of the current products include high levels of caffeine, which may lead to insomnia, digestive issues, high blood pressure, as well as many other physiological problems and/or health concerns. Thus, it would be beneficial to produce such a product that would address these concerns, while catering to consumer tastes.

### SUMMARY OF THE DISCLOSURE

In some embodiments, a method of manufacturing a coffee flavoring or coffee substitute, include providing a predetermined amount of blackseeds, providing a predetermined amount of asafoetida, and roasting the predetermined amount of blackseeds and the predetermined amount of asafoetida.

### BRIEF DESCRIPTION OF THE DISCLOSURE

Various embodiments of the presently disclosed products and methods are shown herein with reference to the drawings, wherein:

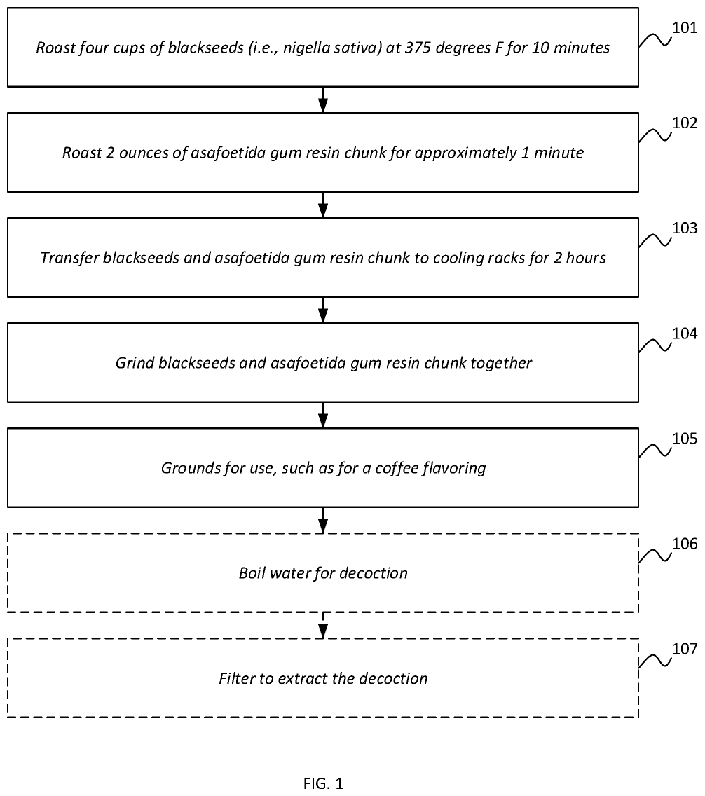

FIG. 1 is a flow chart illustrating one embodiment of the present disclosure; and

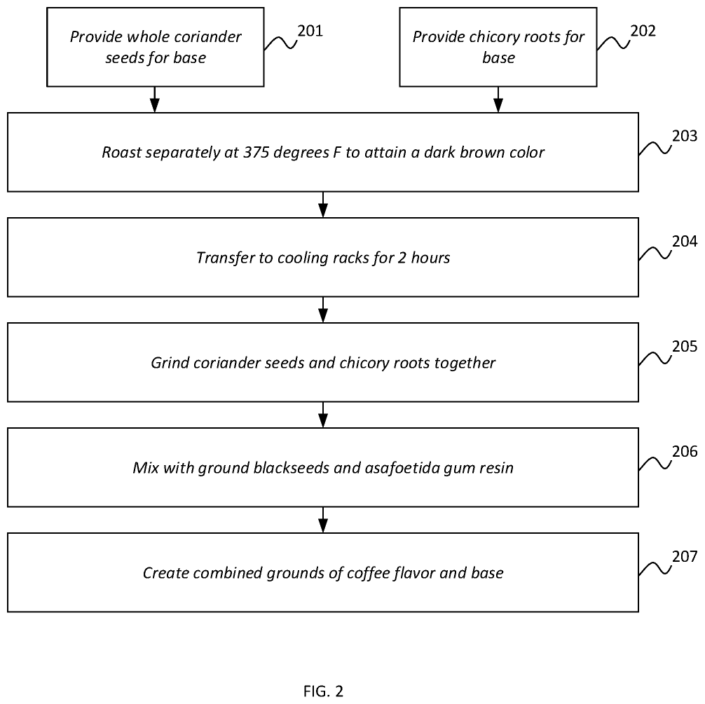

FIG. 2 is a flow chart illustrating another embodiment of the present disclosure.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made in the beverage industry, traditional beverage formulations and methods suffer from some shortcomings as described above.

In at least some examples, the present disclosure relates to herbal coffee flavorings that can be used in coffee as a flavor enhancer and/or as a replacement for the coffee bean. The presently disclosed ingredients may be combined in a process that will results in a formulation that tastes as close to coffee as possible. In at least some examples, this method includes the use of one or more herbs to produce the taste of coffee. In at least some examples, asafoetida, black seeds or a combination of asafoetida and black seeds are used to produce the desire formulation.

In at least some examples, either the asafoetida, the black seeds or the combination of asafoetida and black seeds may be mixed in combination with a coffee product to enhance the coffee's flavor profile. Asafoetida and black seeds individually or in combination may also yield many health benefits. For example, the herb may be ferula asafoetida, a herbaceous plant of the umbelliferae family. It is oleo gum resin obtained from the rhizome and root of plant. This spice is used as a digestive aid, and in food as a condiment and in pickles. The gum resin is antispasmodic, carminative, expectorant, laxative, and sedative. The volatile oil in the gum is eliminated through the lungs, making this an excellent treatment for asthma. The odor of asafoetida is imparted to the breath. Its properties are stimulant, emmenagogue and vermifuge. In addition to its flavor, asafoetida may have medicinal or therapeutic properties for individuals with asthma, epilepsy, stomach-ache, flatulence, intestinal parasites, weak digestion and influenza. The black seed, coriander, and chicory may also have multiple health benefits.

Additionally, the instant formulations and preparations may yield a color, smell, and/or the flavor of coffee to any food, beverage, or edible.

For example, it has been observed that many coffee substitutes lack the flavor and/or texture of coffee. However, with the addition of the disclosed asafoetida and/or black seed combinations, a more robust flavor profile may be obtained with the coffee substitutes. In addition, this preparation of asafoetida and/or black seeds does not compete or clash with the flavor of coffee itself but rather enhances the coffee, making it a perfect supplement to add to one's morning coffee for their additional health benefits.

In at least some examples, the formulation consists of, or includes, one or more of the following ingredients: nigella sativa seeds, and asafoetida gum resin.

In one embodiment, shown in FIG. 1, a composition may be produced to yield an asafoetida-blackseed coffee flavoring. The method may include the following steps, although it will be understood that variations are possible. First, four cups of blackseeds (i.e., nigella sativa) are roasted in a roaster or oven at a temperature of approximately 375 degrees Fahrenheit for a period of about 10 minutes (step 101). A portion of asafoetida gum resin chunk of approximately 2 ounces may also be roasted in a microwave oven at high heat for approximately 1 minute (step 102). The two components may be transferred to a cooling rack to cool for at least 2 hours before grinding (step 103). Next the roasted black seeds and roasted asafoetida are transferred to a grinding machine to be ground to a coffee consistency (step 104), and the resulting grounds may be used to provide a coffee flavoring (step 105).

In some examples, instead of using asafoetida gum resin chunk, a powder form of asafoetida with added ingredients may be used. The asafoetida may also be used without roasting. However, if the roasting process if followed, a microwave, stove top, conventional oven or other suitable device may be used.

In another embodiment, a composition may be produced to be used as a coffee flavoring as a coffee substitute beverage. In this example, water may be boiled may be used to extract the essence that makes the decoction to brew the asafoetida-black seed grounds (step 106). One can use any form of drip method or filtering method to extract the decoction (step 107). The resulting beverage is caffeine-free and, according to some research, the ingredients of this beverage also provide vigor and build the immunity. The coffee flavoring may be taken plain, diluted, or used with a milk or plant-based milks such as almond milk or oat milk. In some examples, the herbal grounds may be brewed using a drip, filter, French press, cafetiere, percolator, espresso machine or other suitable method.

In some embodiments, a coffee substitute base may be produced to add coffee texture and/or color to an existing coffee flavoring as shown in FIG. 2. In this example, a base can be used to add body to the coffee substitute drink. The base may include barley, chicory, or other base or combination that is used in coffee substitute drinks. Alternatively, the base itself may include coffee. In one example, the coffee base includes whole coriander seeds combined with chicory roots to make a robust base (steps 201-202). The coriander seeds and chicory roots may be roasted separately at 375 degrees Fahrenheit until they each attain a dark brown color (step 203). The coriander seeds and the chicory roots may then be transferred to a cooling tray and allowed to cool for 2 hours (step 204). After cooling the ingredients are ground together in a grinder (step 205), and the resulting base grounds can be mixed with the flavoring as previously obtained from step 105 of FIG. 1 (step 206). The combined grounds of coffee flavor and base may then be presented for use (step 207). In some examples, prepared chicory may be used, such as for example, roasted grounds or roasted whole chicory.

In some embodiments, combined herbal coffee grounds may be formed of a coffee substitute base and a coffee flavoring. In this example, the asafoetida-blackseed grounds may be combined with the coriander-chicory base grounds discussed above. The two components may be mixed together in a mixer to form a combined ground that produces a coffee flavored herbal coffee. As previously noted, the herbal grounds may be brewed in any of the disclosed manners, including in a drip, filter, French press, cafetiere, percolator or espresso machine.

In some embodiment, the combined grounds may be used as a coffee substitute beverage. In this example, hot water may be brought to a boiling temperature and used to extract the essence of coffee and create the decoction to brew the combined grounds. Any method of filtering system may be used to obtain the decoction, and the resulting beverage may produce an herbal coffee-substitute having properties similar to coffee. In some examples, coffee may be mixed into the formulation and used as a base, and one can create a healthy drink by mixing the asafoetida-blackseed grounds with the coffee. Alternatively, the base may not be needed to prepare a coffee-flavored beverage from the asafoetida-black seed grounds, and the composition may itself serve as a stand-alone coffee substitute drink.

It will be understood that the asafoetida-blackseed combination disclosed herein may be used by itself or in combination with other ingredients that result in a coffee flavor with varying flavor profiles. The asafoetida-blackseed combination may also be used in coffee as a supplement and/or as an ingredient added to coffee. The asafoetida-blackseed combination may also be used in any product where a coffee flavoring is wanted such as drinks, candy, tea, ice cream, and other foods. Additionally, the formulation may be used as a health supplement or ingredient in any food product where any trace of coffee flavoring is resulted, or added to a coffee product or a coffee-flavored product.

Variations of the above-described methods and products are possible. For example, though one tablespoon of the blends described above may be used to make a cup of coffee, the ratio of ingredients may be varied as desired for a specific flavor and/or texture. Additionally, a supplement may be made which includes additional ingredients, such as vitamins and/or minerals. The Herbal blend coffee supplement may also be used in conjunction with the regular coffee to lower the caffeine content. Decoctions of this herbal coffee can be freeze-dried to create instant coffee, and may also be used to make cold or iced coffees. The herbal coffee brew may be made as concentrate and kept in the refrigerator for up to a week and diluted and used as necessary. The herbal coffee blend may use additional added ingredients such as turmeric, cumin, sesame seeds to create exotic flavorings and health benefits. Finally, the herbal coffee products and supplements described may have a relatively long shelf of up to 6 months in an airtight container.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. A method of manufacturing a coffee flavoring or coffee substitute, comprising:
providing a predetermined amount of blackseeds;
providing a predetermined amount of asafoetida; and
roasting the predetermined amount of blackseeds and the predetermined amount of asafoetida.

2. The method of claim 1, wherein roasting the predetermined amount of blackseeds comprises roasting the blackseeds at 375 degrees Fahrenheit for 10 minutes.

3. The method of claim 1, wherein roasting the predetermined amount of asafoetida comprises roasting the asafoetida for one minute.

4. The method of claim 1, further comprising the step of transferring the predetermined amount of blackseeds and the predetermined amount of asafoetida to at least one cooling rack and letting the predetermined amount of blackseeds and the predetermined amount of asafoetida cool for 2 hours.

5. The method of claim 1, further comprising the step of grinding the roasted predetermined amount of blackseeds and the predetermined amount of asafoetida together to create flavoring grounds.

6. The method of claim 1, further comprising the step of boiling water for decoction.

7. The method of claim 6, further comprising the step of filtering to extract a decoction of the grounds.

8. The method of claim 1, further comprising the step of providing whole coriander seeds for use as part of a base.

9. The method of claim 1, further comprising the step of providing chicory roots for use as part of a base.

10. The method of claim 1, further comprising the step of providing chicory roots and whole coriander seeds for use as part of a base.

11. The method of claim 10, further comprising the step of roasting the chicory roots and the whole coriander seeds at 375 degrees Fahrenheit to attain a dark brown color.

12. The method of claim 11, further comprising the step of transferring the roasted chicory roots and the whole coriander seeds to a cooling rack for two hours.

13. The method of claim 12, further comprising the step of grinding the roasted chicory roots and the whole coriander seeds together to create a ground base.

14. The method of claim 13, further comprising the step of mixing the ground base and the flavoring grounds.

15. A coffee flavoring, comprising:
a predetermined amount of roasted blackseeds; and
a predetermined amount of roasted asafoetida.

16. A coffee substitute comprising:
the coffee flavoring of claim 15; and
a base comprised of at least one of roasted whole coriander seeds and roasted chicory roots.

17. The coffee substitute of claim 16, wherein the base comprises both roasted whole coriander seeds and roasted chicory roots.
